(19) United States
(12) Patent Application Publication
(10) Pub. No.: US 2017/0090421 A1
(43) Pub. Date: Mar. 30, 2017

(54) IMAGE RECORDING DEVICE

(71) Applicant: FUJI XEROX CO., LTD., Tokyo (JP)

(72) Inventors: Jiro MINABE, Kanagawa (JP); Yasuhiro OGASAWARA, Kanagawa (JP); Shigetoshi NAKAMURA, Kanagawa (JP); Takashi KIKUCHI, Kanagawa (JP); Masahiro IGUSA, Kanagawa (JP); Motohiko SAKAMAKI, Kanagawa (JP)

(73) Assignee: FUJI XEROX CO., LTD., Tokyo (JP)

(21) Appl. No.: 15/053,000

(22) Filed: Feb. 25, 2016

(30) Foreign Application Priority Data
Sep. 24, 2015 (JP) 2015-186835

(51) Int. Cl. G03H 1/26; G03H 1/04

(52) U.S. Cl. CPC G03H 1/268; G03H 1/265; G03H 1/0402; G03H 1/041; G03H 2001/0426

(57) ABSTRACT

An image recording device includes a laser beam source that emits a laser beam, a splitting unit that splits the laser beam emitted from the laser beam source into two laser beams, a display device that displays images over a display area thereof divided into segments, a display controller that controls display of the display device so that images for forming a holographic stereogram are displayed on the segments of the display area and so that one of the laser beams is modulated by the images displayed on the display device to become object beams, an optical system that images the object beams on a hologram recording medium so that the object beams are superimposed one on top of another, and an irradiating unit that irradiates the hologram recording medium with, besides the object beams, the other laser beam split by the splitting unit as a reference beam.

### CROSS-REFERENCE TO RELATED APPLICATIONS

This application is based on and claims priority under 35 USC 119 from Japanese Patent Application No. 2015-186835 filed Sep. 24, 2015.

### BACKGROUND

### Technical Field

The present invention relates to image recording devices.

### SUMMARY

According to an aspect of the invention, an image recording device includes a laser beam source that emits a laser beam, a splitting unit that splits the laser beam emitted from the laser beam source into two laser beams, a display device that displays images over a display area thereof divided into segments, a display controller that controls display of the display device so that images for forming a holographic stereogram are displayed on the segments of the display area and so that one of the laser beams split by the splitting unit is modulated by the images displayed on the display device to become object beams, an optical system that images the object beams on a hologram recording medium so that the object beams are superimposed one on top of another, and an irradiating unit that irradiates the hologram recording medium with, besides the object beams, the other laser beam split by the splitting unit as a reference beam.

### BRIEF DESCRIPTION OF THE DRAWINGS

Exemplary embodiments of the present invention will be described in detail based on the following figures, wherein:

FIG. 1 is a schematic diagram of an example of an original image;

FIG. 2 is a schematic diagram illustrating the principle of a holographic stereogram;

FIG. 3 is a configuration diagram of an example of a configuration of an image recording device according to a first exemplary embodiment;

FIG. 4 is a block diagram of an example of an electric configuration of an image recording device;

FIG. 5 is a schematic diagram of an imaging function of an optical system according to the first exemplary embodiment;

FIGS. 6A to 6C are schematic diagrams of examples of multiple images displayed on a display device according to the first exemplary embodiment;

FIGS. 7A to 7C are schematic diagrams of examples of multiple images displayed on a display device according to a second exemplary embodiment;

FIG. 8 is a configuration diagram of an example of a configuration of an image recording device according to a third exemplary embodiment;

FIG. 9 is a configuration diagram of an example of a configuration of an image recording device according to a fourth exemplary embodiment;

FIG. 10 is a configuration diagram of a modified example of the optical system according to the fourth exemplary embodiment;

FIG. 11 is a configuration diagram of an example of a configuration of an image recording device according to a fifth exemplary embodiment;

FIG. 12 is a schematic diagram of an example of multiple images displayed on a display device according to a sixth exemplary embodiment;

FIG. 13 is a configuration diagram of an example of a configuration of an image recording device according to the sixth exemplary embodiment; and

FIG. 14 is a schematic diagram of an example of multiple images displayed on a display device according to a fifth exemplary embodiment.

### DETAILED DESCRIPTION

Referring now to the drawings, exemplary embodiments of the invention are described in detail below.

### Principle of Holographic Stereogram

Now, the principle of a holographic stereogram is described first.

One way of displaying a three-dimensional image is a holographic stereogram. A holographic stereogram is formed by acquiring two-dimensional images of an object photographed from different viewpoints slightly sifted from one another as original images, reconstructing the acquired multiple original images to generate multiple display images that are displayed on a display device, and sequentially recording the generated multiple display images on one hologram recording medium as multiple component holograms. In the following description, original images and display images are collectively called “parallax images”.

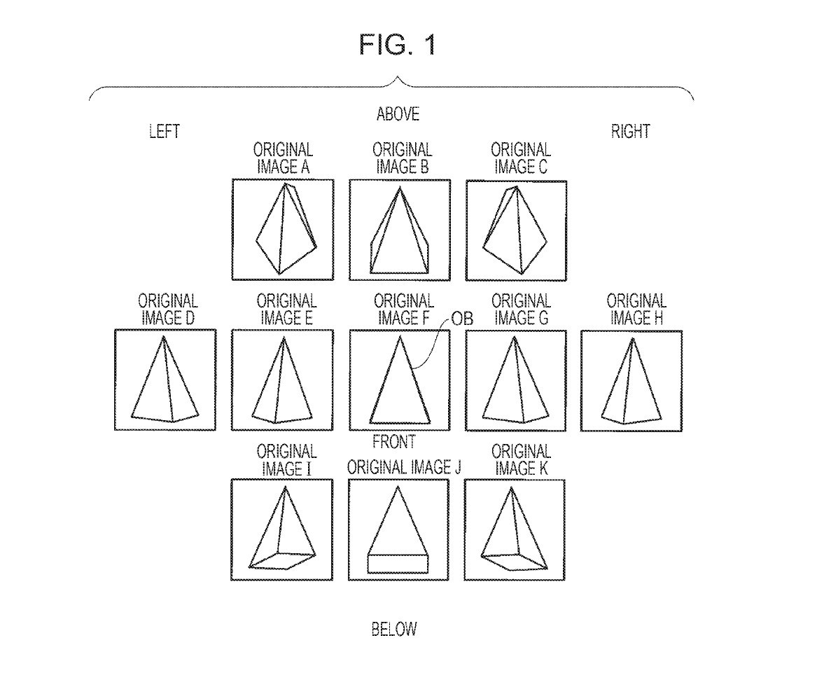

FIG. 1 is a schematic diagram of examples of original images. In these examples, a quadrangular pyramid is used as an object OB and the object OB is photographed from different viewpoints slightly shifted from one another. An image of the object OB photographed from the front is an original image F. An image of the object OB photographed from obliquely left in the horizontal direction is an original image E and an image of the object OB photographed from a position rotated further leftward from the position at which the original image E is photographed is an original image D. An image of the object OB photographed from obliquely right in the horizontal direction is an original image G and an image of the object OB photographed from a position rotated further rightward from the position at which the original image G is photographed is an original image H.

An image of the object OB photographed from the front and obliquely above is an original image B and an image of the object OB photographed from the front and obliquely below is an original image J. An image of the object OB photographed from obliquely left and obliquely above is an original image A and an image of the object OB photographed from obliquely left and obliquely below is an original image I. An image of the object OB photographed from obliquely right and obliquely above is an original image C and an image of the object OB photographed from obliquely right and obliquely below is an original image K.

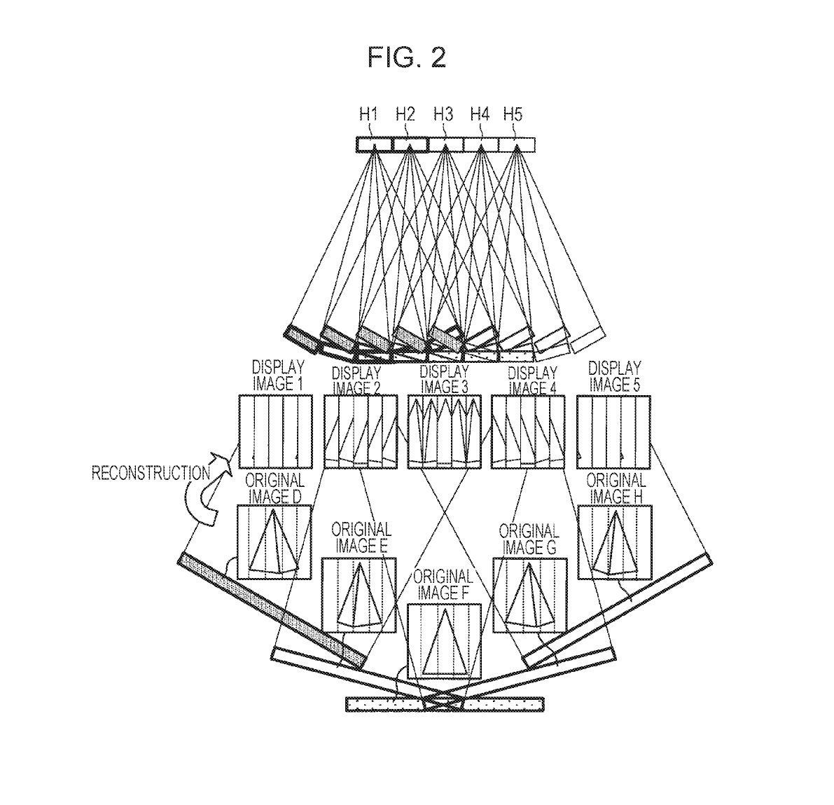

FIG. 2 is a schematic diagram illustrating the principle of a holographic stereogram. For example, to form a holographic stereogram having horizontal parallax information, an object OB is sequentially photographed from different viewpoints slightly shifted from one another in the horizontal direction as illustrated in FIG. 2. Here, it is assumed that original images D, E, F, G, and H are acquired as a result of photographing the object OB.

Subsequently, these original images D to H are reconstructed to generate display images 1, 2, 3, 4, and 5. In this example, each original image is divided into five segments in the horizontal direction and then an image acquired by arranging n-th (n is an integer from one to five) pixel columns of the original images D to H from the left in this order serves as a display image n. Then, display images 1 to 5 are sequentially recorded on a hologram recording medium as strip-shaped component holograms H1, H2, H3, H4, and H5.

Image surfaces of the original images D to H correspond to a surface of the hologram recording medium constituted of the component holograms H1 to H5. The converging angles of the display images 1 to 5 correspond to observation angles at which an observer observes the hologram recording medium. Specifically, angle dependence information of each pixel column of the display image is recorded. Thus, by reproducing the component holograms H1 to H5, the entirety of the hologram (that is, the original images D to H) is reproduced, whereby a three-dimensional image of the object OB is recognized by an observer.

A holographic stereogram having horizontal parallax information does not have vertical parallax information and thus has a narrow field of view in the vertical direction. As an existing method for providing vertical parallax information to a holographic stereogram having horizontal parallax information, a method has been developed in which, to record component holograms, the optical deflector disposed in front of the hologram recording medium is disposed at various different deflection angles to expose the hologram recording medium to multiple object beams incident at different angles. However, the exposure to multiple object beams requires a long time for forming a holographic stereogram. Moreover, since only the angle is changed in immediate front of the hologram recording medium, the size of a component hologram projected on the hologram recording medium is changed and complex image processing for correcting the size change is required.

An image recording device according to the exemplary embodiment displays multiple images on respective segments of the display area of a display device. The multiple images may be images having parallax in the same direction or may be images having parallax in different directions. Multiple object beams that have been transmitted through the displayed multiple images are imaged while being superimposed one on top of another by the optical system on the hologram recording medium. In this manner, multiple component holograms are recorded so as to be superimposed one on top of another at a time over the same area of the hologram recording medium when a holographic stereogram is formed. In addition, an optical system (hereinafter also referred to as a “superimposing imaging optical system”) according to the exemplary embodiment dispenses with complex image processing required in superimposing to prevent the size of display images from changing depending on the angle at which the light beam is incident on the hologram recording medium. The specific configuration of the image recording device and the display images are described below.

### First Exemplary Embodiment

### Image Recording Device

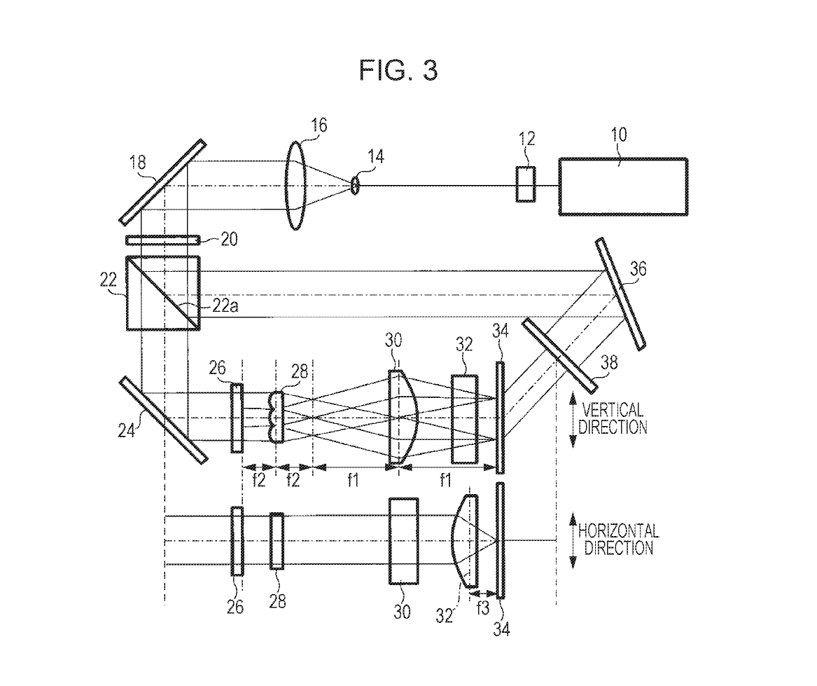

The following describes an image recording device that forms a holographic stereogram by sequentially recording component holograms. FIG. 3 is a configuration diagram of an example of the configuration of an image recording device according to a first exemplary embodiment. In this exemplary embodiment, an image recording device that forms a holographic stereogram having horizontal parallax information is described. FIG. 3 is a top view of the image recording device.

As illustrated in FIG. 3, the image recording device includes a laser beam source 10. The laser beam source 10 emits coherent laser beams by lasing. In this exemplary embodiment, a green solid state laser that emits laser beams of a wavelength of 532 nm and has a light output of 1 W is used as an example of the laser beam source 10.

A shutter 12 for blocking laser beams is disposed on the light emitting side of the laser beam source 10 in such a manner as to be retractable from the optical path. On the light transmission side of the shutter 12, a spatial filter 14, a lens 16, and a mirror 18 are disposed in this order from the shutter 12 along the optical path. The spatial filter 14 and the lens 16 collimate light that has been transmitted therethrough along the optical path from which the shutter 12 has been retracted and irradiate the mirror 18 with the collimated light. The mirror 18 changes the optical path of the collimated light toward a polarization beam splitter 22.

On the light reflection side of the mirror 18, a half-wave plate 20 and the polarization beam splitter 22 are disposed in this order from the mirror 18 along the optical path. The half-wave plate 20 adjusts the ratio between the intensities of a signal beam and a reference beam by rotating a polarization direction on which the incident light is polarized. The light that has been transmitted through the half-wave plate 20 is incident on the polarization beam splitter 22.

The polarization beam splitter 22 includes a reflection surface 22a that transmits p-polarized beams and that reflects s-polarized beams. The polarization beam splitter 22 splits a laser beam into two types of light, that is, light for an object beam and light for a reference beam. The light that has been transmitted through the polarization beam splitter 22 becomes light for an object beam (p-polarized beam) and the light that has been reflected by the polarization beam splitter 22 becomes light for a reference beam (s-polarized beam).

An optical system that generates an object beam is described first. A mirror 24 is disposed on the light transmission side of the polarization beam splitter 22. The mirror 24 changes the optical path of the transmitted light toward a hologram recording medium 34. A transmissive display device 26, a lens array 28, a lens 30, and a lens 32 are disposed between the mirror 24 and the hologram recording medium 34 in this order from the mirror 24 along the optical path.

The display device 26 includes multiple pixels. The display device 26 displays images in accordance with image information by modulating at least one of the amplitude, the phase, and the polarization direction of the incident light per pixel. Examples preferably usable as the display device 26 include a spatial light modulator that drives and controls each pixel using electric signals. In this exemplary embodiment, a transmissive liquid crystal spatial light modulator is used to display images over its display area. After the light for an object beam is modulated by the display device 26, an object beam used for hologram recording is generated. Here, the polarization direction of an object beam and the polarization direction of a reference beam may be varied as long as interference fringes constituted of the object beams and the reference beam are recordable on the hologram recording medium. Other combinations of the polarization directions are possible.

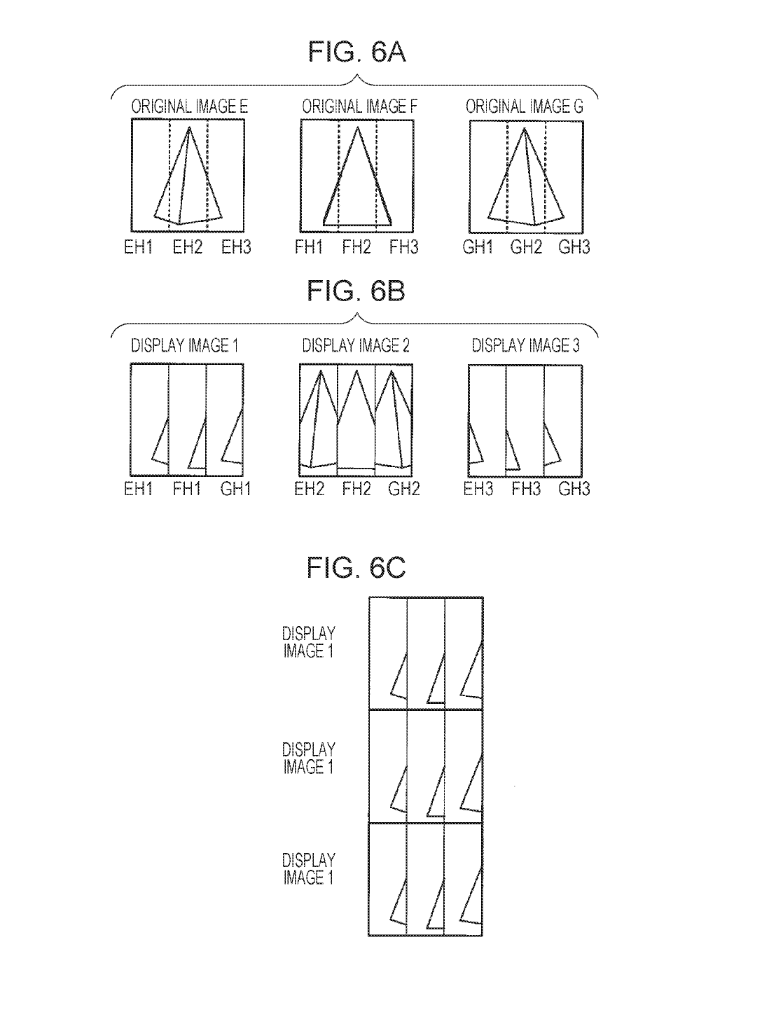

In this exemplary embodiment, the display area of the display device 26 is divided into multiple segments in the vertical direction to display multiple images. In the example illustrated in FIG. 3, the display area of the display device 26 is divided into three segments in the vertical direction. One image is displayed on each of the three segments of the display area, so that three images arranged side by side in the vertical direction are displayed over the display area of the display device 26. The display image is described below (see FIG. 6).

Here, the direction perpendicular to the plane of FIG. 3 corresponds to the “horizontal direction” and the direction parallel to the plane of FIG. 3 corresponds to the “vertical direction”. Strip-shaped component holograms are recorded in such a manner that their lengthwise direction corresponds to the “vertical direction” and their widthwise direction corresponds to the “horizontal direction”. The hologram recording medium 34 is held by a holding member, not illustrated. The hologram recording medium 34 is moved in the horizontal direction by a moving device, not illustrated, every time after recording of one component hologram is finished in accordance with display of images displayed at a time on the display device 26.

The lens array 28 includes multiple cylindrical convex lenses. Each of the multiple cylindrical convex lenses is disposed so that its convex surface faces the display device 26 and its lengthwise direction coincides with the horizontal direction. The multiple cylindrical convex lenses are arranged side by side in the vertical direction so as to correspond to the respective segments of the display area of the display device 26.

The lens 30 is a cylindrical lens. The lens 30 is disposed so that its convex surface faces the lens 32 and its lengthwise direction coincides with the horizontal direction. The lens 30 functions as an imaging lens that images the object beams that have been transmitted through the lens array 28 on the hologram recording medium 34 so that the object beams are superimposed one on top of another.

The lens 32 is also a cylindrical lens. The lens 32 is disposed so that its convex surface faces the lens 30 and its lengthwise direction coincides with the vertical direction. The lens 32 functions as a converging lens that converges in the horizontal direction the object beams that have been transmitted through the lens array 28 and the lens 30. The state where the object beam is converged in the horizontal direction is illustrated in an appended side view.

FIG. 5 is a schematic diagram of an imaging function of the optical system according to the first exemplary embodiment. A focal length f1 of the lens 30 and a focal length f2 of each cylindrical convex lens of the lens array 28 are determined so that, when the display device 26 is located at a focal point of each cylindrical convex lens of the lens array 28, the surface of the hologram recording medium 34 serves as an imaging surface on which an image displayed on the display device 26 is formed. A focal length f3 of the lens 32 is determined so that the surface of the hologram recording medium 34 serves as a converging surface.

The display device 26 displays multiple images over its display area divided into multiple segments in the vertical direction. Multiple object beams that have been transmitted through the multiple images are transmitted through the corresponding cylindrical convex lenses of the lens array 28. The multiple object beams that have been transmitted through the lens array 28 are imaged on the hologram recording medium 34 by the lens 30 while being superimposed one on top of another in the vertical direction. Specifically, the optical axes of the imaged multiple object beams have different angles from one another in the vertical direction. The multiple object beams that have been transmitted through the lens 30 are converged in the horizontal direction by the lens 32. The object beams thus imaged and converged are applied to the hologram recording medium 34.

Now, an optical system that generates a reference beam is described. A mirror 36 is disposed on the light reflection side of the polarization beam splitter 22. The mirror 36 changes the optical path of light for a reference beam (hereinafter the light is referred to as a “reference beam”) toward the hologram recording medium 34. A slit 38 is disposed between the mirror 36 and the hologram recording medium 34.

The slit 38 shapes the reference beam into a rectangle and the shaped reference beam is applied to the hologram recording medium 34. In this exemplary embodiment, the reference beam is applied to the hologram recording medium 34 from the side different from the side from which each object beam is applied. In addition, the reference beam is applied in such a manner that the optical axis of the reference beam and the optical axis of each object beam cross each other inside the hologram recording medium 34.

The above-described optical system is an example and components such as a lens or a mirror may be omitted or added in accordance with the design. For example, a slit that shapes each object beam into a rectangle or a diffuser that diffuses each object beam in at least one of the horizontal direction and the vertical direction may be disposed on the optical path.

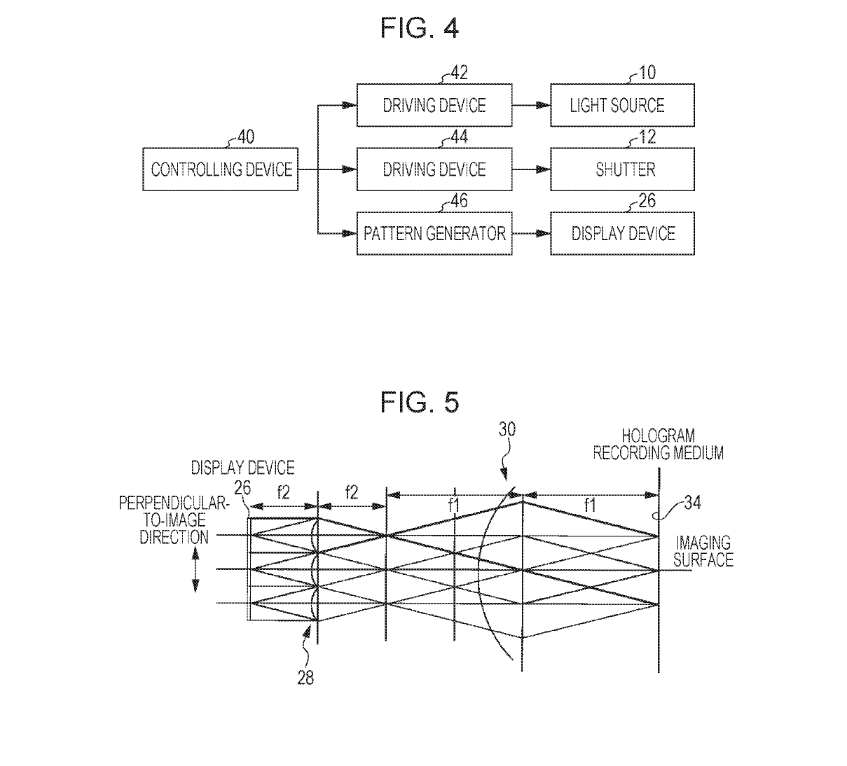

Subsequently, an electric configuration of the image recording device is described. FIG. 4 is a block diagram of an example of an electric configuration of the image recording device. The image recording device includes a controlling device 40 that controls the entirety of the device. The controlling device 40 is formed of a computer and includes a central processing unit (CPU), a read only memory (ROM) that stores various programs, a random access memory (RAM) that is used as a work area in the execution of the programs, and a nonvolatile memory that stores various types of information.

The laser beam source 10 is connected to the controlling device 40 with a driving device 42 interposed therebetween. The driving device 42 turns on the laser beam source 10 in response to a command from the controlling device 40. The shutter 12 is also connected to the controlling device 40 with a driving device 44 interposed therebetween. The driving device 44 opens and closes the shutter 12 in response to a command from the controlling device 40.

The display device 26 is also connected to the controlling device 40 with a pattern generator 46 interposed therebetween. The pattern generator 46 generates patterns in accordance with image information supplied from the controlling device 40. Multiple pixels of the display device 26 modulate incident light in accordance with the patterns, so that images corresponding to the image information are displayed. Specifically, display of the display device 26 is controlled by the controlling device 40 with the pattern generator 46 interposed therebetween. Rotation of the half-wave plate 20, driving of a moving device, not illustrated, and other operations of other components are also performed by driving devices, not illustrated, in response to commands from the controlling device 40.

### Collective Recording of Multiple Component Holograms

Subsequently, a hologram recording process is described.

The driving device 42 is driven first to retract the shutter 12 from the optical path in order to allow a laser beam to pass through the optical path. A laser beam is emitted from the laser beam source 10. Concurrently, image information is provided from the controlling device 40 to the pattern generator 46 and multiple images are displayed on the display device 26 at predetermined timing. Thus, a hologram recording process is performed on the hologram recording medium 34.

Here, multiple images displayed on the display device 26 are described.

FIGS. 6A to 6C are schematic diagrams of examples of multiple images displayed on the display device 26 according to the first exemplary embodiment. As illustrated in FIG. 6A, the object OB is sequentially photographed from different viewpoints slightly shifted from one another in the horizontal direction to obtain three original images E, F, and G. Subsequently, as illustrated in FIG. 6B, the three original images E, F, and G are reconstructed to generate display images 1, 2, and 3. As in the same manner as described above using FIG. 2, an image acquired by dividing original images into three segments in the horizontal direction and arranging n-th pixel columns of the images E, F, and G from the left in order of the images E, F, and G is defined as a display image n.

For example, the pixel columns acquired from the original image E are denoted by EH1, EH2, and EH3, the pixel columns acquired from the original image F are denoted by FH1, FH2, and FH3, and the pixel columns acquired from the original image G are denoted by GH1, GH2, and GH3. The pixel columns EH1, FH1, and GH1 are arranged in the display image 1, the pixel columns EH2, FH2, and GH2 are arranged in the display image 2, and the pixel columns EH3, FH3, and GH3 are arranged in the display image 3.

In the first exemplary embodiment, multiple images displayed on the display device 26 are identical display images. The display area of the display device 26 is divided into multiple segments in the vertical direction and identical display images are displayed in each segment. Specifically, multiple identical display images are displayed so as to be arranged in the vertical direction. Multiple initial display images are displayed at a time and component holograms corresponding to the multiple display images are recorded on the hologram recording medium 34 at a time. Subsequently, the hologram recording medium 34 is moved and subsequent multiple display images are then displayed, and component holograms corresponding to the multiple display images are recorded on the hologram recording medium 34 at a time.

As illustrated in FIG. 6C, for example, the display area is divided into three segments in the vertical direction and three display images 1 are displayed and recorded on the hologram recording medium 34 at a time. Subsequently, the hologram recording medium 34 is moved and three display images 2 are displayed and recorded on the hologram recording medium 34 at a time. Then, the hologram recording medium 34 is moved, three display images 3 are displayed and recorded on the hologram recording medium 34 at a time. In this manner, recording on and moving of the hologram recording medium 34 are repeated.

The description is returned here to the hologram recording process. A laser beam emitted from the laser beam source 10 is collimated by the spatial filter 14 and the lens 16, the collimated beam is reflected by the mirror 18, and the reflected beam is incident on the half-wave plate 20. The laser beam having its polarization direction rotated at the half-wave plate 20 is incident on the polarization beam splitter 22 and split into a light beam for an object beam (p-polarized beam) and a light beam for a reference beam (s-polarized beam).

The p-polarized beam that has been transmitted through the polarization beam splitter 22 is reflected by the mirror 24 and modulated by the display device 26 in accordance with image information to become object beams. In this exemplary embodiment, multiple identical display images are displayed on the display device 26 so as to be arranged in the vertical direction. Multiple object beams that have been transmitted through the multiple display images are transmitted through corresponding cylindrical convex lenses of the lens array 28, are imaged on the hologram recording medium 34 by the lens 30 while being superimposed one on top of another, are converged by the lens 32 in the horizontal direction, and are applied to the hologram recording medium 34.

On the other hand, the s-polarized beam (reference beam) reflected by the polarization beam splitter 22 is reflected by the mirror 36, shaped by the slit 38 into a rectangle, and then applied to the hologram recording medium 34 from the side different from the side from which the object beams are applied thereto.

In this exemplary embodiment, multiple identical display images are displayed on the display device 26 so as to be arranged in the vertical direction. A light beam that has been transmitted through the multiple display images arranged in the vertical direction becomes multiple object beams having optical axes whose angles vary in the vertical direction in accordance with the displayed positions of the display images. The reference beam and the multiple object beams corresponding to the multiple display images are concurrently applied to the hologram recording medium 34, so that component holograms corresponding to the multiple images are recorded at a time using interference between the multiple object beams and the reference beam.

Component holograms corresponding to multiple images are recorded over the same area of the hologram recording medium 34 so as to be superimposed one on top of another. The component holograms corresponding to multiple images that have been recorded so as to be superimposed are reproduced in such a manner as to be expanded from the hologram recording medium 34. Thus, the field of view in the vertical direction is expanded when a holographic stereogram having horizontal parallax information is formed.

In addition, a reflection hologram is recorded as a result of irradiating the hologram recording medium 34 with the reference beam from the side different from the side from which the hologram recording medium 34 is irradiated with the object beams. In this exemplary embodiment, multiple component holograms that are to be recorded so as to be superimposed one on top of another are in a strip shape. By moving the hologram recording medium 34 in the horizontal direction and switching the images displayed on the display device 26 from one to another, strip-shaped component holograms that are to be recorded so as to be superimposed one on top of another are sequentially recorded on the hologram recording medium 34 so as to be arranged in the horizontal direction. When a light beam including a component of the wavelength the same as the wavelength of the laser beam used for recording is thus applied to all the recorded component holograms from the direction the same as the direction of the reference beam or opposite to the direction of the reference beam, different original images are allowed to be reproduced in accordance with different observation directions.

### Second Exemplary Embodiment

In the second exemplary embodiment, multiple images displayed on the display device 26 are called multiple display images acquired at different angles in the vertical direction. These display images are acquired by rearranging multiple original images having horizontal parallax information. The multiple display images are displayed so as to be arranged in the vertical direction. Except that the images displayed on the display device 26 are changed, the second exemplary embodiment has the same components as those of the first exemplary embodiment. Thus, only the different points are described and the same components are not described.

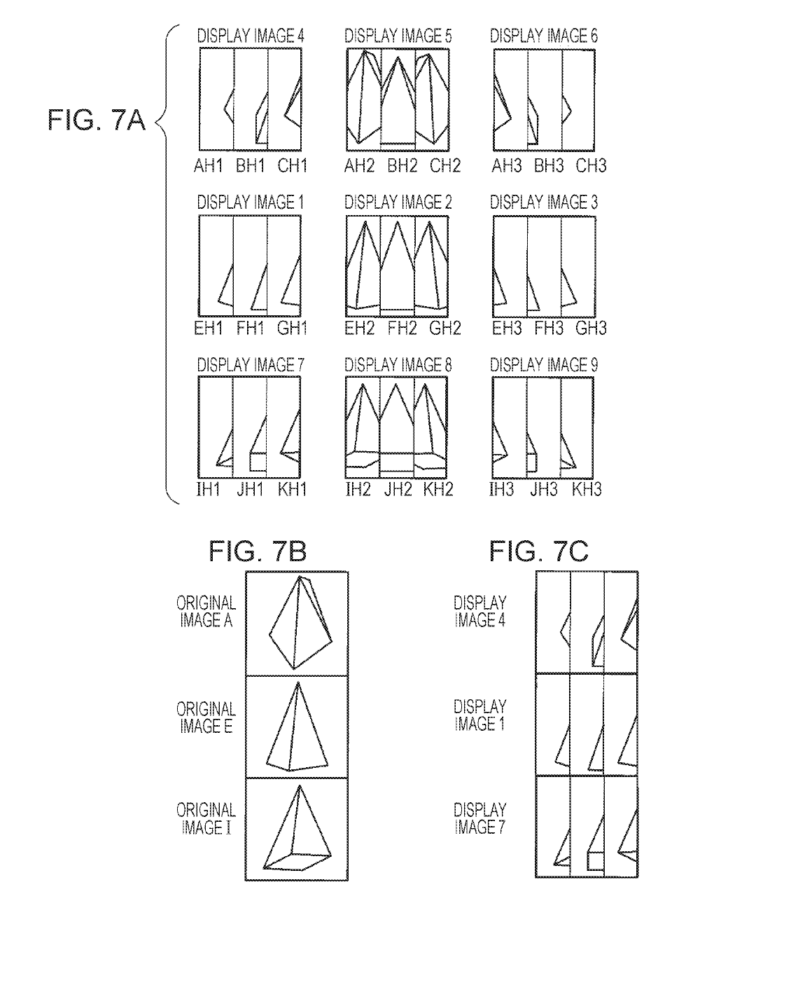

FIGS. 7A to 7C are schematic diagrams of examples of multiple images displayed on the display device 26 according to the second exemplary embodiment. As illustrated in FIG. 7A, in the same manner as in the case of the first exemplary embodiment, with which three original images E, F, and G acquired at the same angle in the vertical direction are rearranged to generate display images 1, 2, and 3, three original images A, B, and C acquired at the same angle in the vertical direction are rearranged to generate display images 4, 5, and 6, and three original images I, J, and K acquired at the same angle in the vertical direction are rearranged to generate display images 7, 8, and 9.

In this example, as illustrated in FIG. 7C, the display area of the display device 26 is divided into three segments in the vertical direction and the multiple display images 4, 1, and 7 acquired at different angles in the vertical direction are displayed so as to be arranged in the vertical direction. As described above, each of the multiple display images 4, 1, and 7 is a parallax image acquired by rearranging multiple original images having horizontal parallax information. Here, the angle of the optical axis of each object beam incident on the hologram recording medium 34 from the corresponding display image is caused to coincide with the angle in the vertical direction at which the original image is acquired.

For example, as illustrated in FIG. 7B, the image acquired by photographing the object OB from obliquely left in the horizontal direction and obliquely upward is an original image A, the image acquired by photographing the object OB from obliquely left in the horizontal direction is an original image E, and the image acquired by photographing the object OB from obliquely left in the horizontal direction and obliquely downward is an original image I. The original images A, E, and I are acquired at different angles in the vertical direction.

The angle of the optical axis of the object beam that has been transmitted through the display image 4 corresponds to the angle in the vertical direction at which the original image A is acquired. The angle of the optical axis of the object beam that has been transmitted through the display image 1 corresponds to the angle in the vertical direction at which the original image E is acquired. The angle of the optical axis of the object beam that has been transmitted through the display image 7 corresponds to the angle in the vertical direction at which the original image I is acquired.

In the second exemplary embodiment, multiple display images acquired at different angles in the vertical direction are displayed on the display device 26 so as to be arranged in the vertical direction. Light beams that have been transmitted through multiple display images arranged in the vertical direction become multiple object beams having optical axes whose angles vary in the vertical direction corresponding to the directions of parallax. The reference beam and these multiple object beams are concurrently applied to the hologram recording medium 34 and interference between the multiple object beams and the reference beam allows component holograms corresponding to the multiple images to be recorded on the hologram recording medium 34 at a time.

Component holograms corresponding to multiple images are recorded over the same area of the hologram recording medium 34 so as to be superimposed. From the component holograms corresponding to multiple images thus recorded so as to be superimposed one on top of another, images having parallax in different directions are reproduced at different observation angles. In other words, a holographic stereogram having horizontal parallax information is provided with vertical parallax information. That is, a holographic stereogram having both of horizontal parallax information and vertical parallax information is formed.

In an existing image recording device, to form a holographic stereogram having both of horizontal parallax information and vertical parallax information, fine component holograms are recorded pixel by pixel by converging light in the horizontal direction and the vertical direction. In contrast, in the image recording device according to the second exemplary embodiment, the vertical parallax is provided to a holographic stereogram by the superimposing imaging optical system and information of parallax for multiple images in a direction corresponding to the longitudinal direction of a strip-shaped component hologram is recorded at a time. Thus, the speed at which component holograms are recorded is significantly higher than that in the case of an existing image recording device.

Assuming that, for example, a strip-shaped component hologram has image information for 100 pixels in the longitudinal direction, the speed at which recording on a holographic stereogram is performed is 100 times higher than that in the case of an existing image recording device that performs recording pixel by pixel.

### Third Exemplary Embodiment

A third exemplary embodiment has the same components as those of the first exemplary embodiment except that one convex lens is used instead of two cylindrical lenses illustrated as the lens 30 and the lens 32 in FIG. 3. Thus, only the different points are described and the same components are not described.

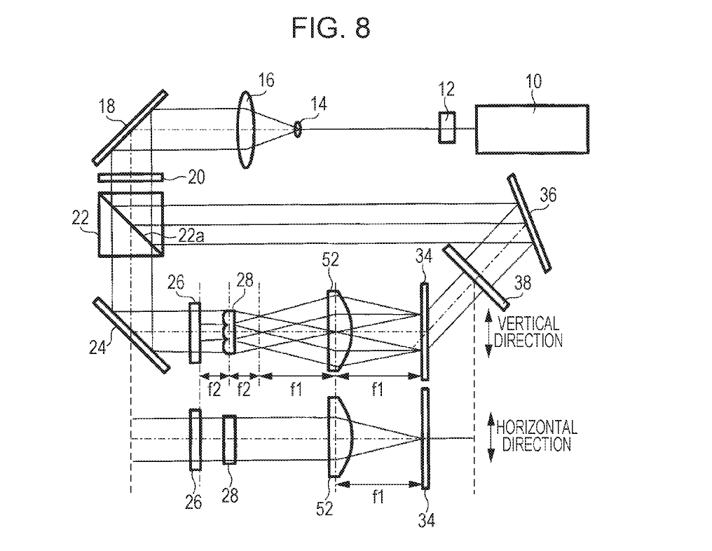

FIG. 8 is a configuration diagram of an example of the configuration of an image recording device according to a third exemplary embodiment. As illustrated in FIG. 8, in the third exemplary embodiment, a transmissive display device 26, a lens array 28, and a lens 52 are disposed between a mirror 24 and a hologram recording medium 34 in this order from the mirror 24 along the optical path.

The lens 52 is a convex lens. The lens 52 functions as an imaging lens that images object beams that have been transmitted through the lens array 28 on the hologram recording medium 34 so that the object beams are superimposed one on top of another. The lens 52 also functions as a converging lens that converges in the horizontal direction the object beams that have been transmitted through the lens array 28. The way how the object beams are converged in the horizontal direction is illustrated in an appended side view.

A focal length f1 of the lens 52 and the focal length f2 of each cylindrical convex lens of the lens array 28 are determined so that, when the display device 26 is disposed at the focal point of each cylindrical convex lens of the lens array 28, the surface of the hologram recording medium 34 serves as an imaging surface on which an image displayed on the display device 26 is formed. In addition, the focal length f1 of the lens 52 is determined so that the surface of the hologram recording medium 34 serves as a converging surface.

The display device 26 displays multiple images over the display area divided into segments in the vertical direction. Multiple object beams that have been transmitted through the corresponding multiple images are transmitted through the corresponding cylindrical convex lenses of the lens array 28. The multiple object beams that have been transmitted through the lens array 28 are imaged and converged by the lens 52 and applied to the hologram recording medium 34. By replacing two cylindrical lenses with one convex lens, the optical system is further simplified than that in the case of the first exemplary embodiment.

### Fourth Exemplary Embodiment

A fourth exemplary embodiment has the same components as those in the case of the first exemplary embodiment except that the lens array including multiple cylindrical convex lenses illustrated as the lens array 28 in FIG. 3 is replaced with a lens array including multiple cylindrical concave lenses. Thus, only the different points are described and the same components are not described.

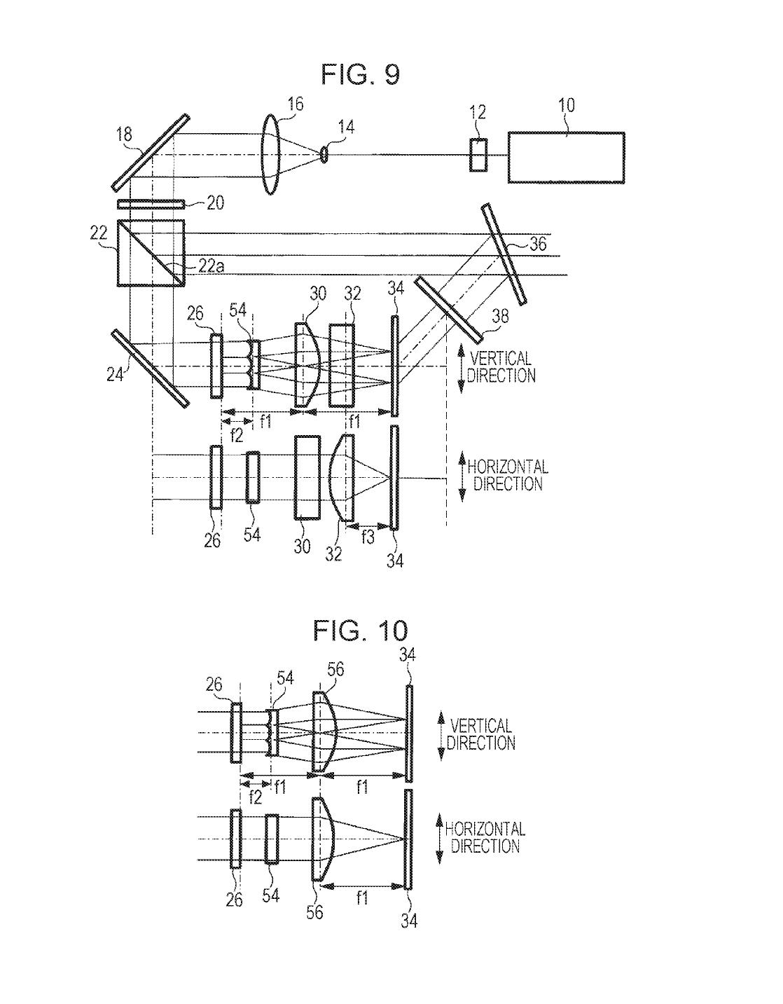

FIG. 9 is a configuration diagram is an example of a configuration of an image recording device according to the fourth exemplary embodiment. As illustrated in FIG. 9, in the fourth exemplary embodiment, a transmissive display device 26, a lens array 54, a lens 30, and a lens 32 are disposed between the mirror 24 and the hologram recording medium 34 in this order from the mirror 24 along the optical path.

The lens array 54 includes multiple cylindrical concave lenses. Each of the multiple cylindrical concave lenses is disposed so that its concave surface faces the display device 26 and so that its lengthwise direction coincides with the horizontal direction. The multiple cylindrical concave lenses are arranged in the vertical direction so as to correspond to the respective segments of the display area of the display device 26.

The focal length f1 of the lens 30 and a focal length f2 of each cylindrical concave lens of the lens array 54 are determined so that, when the display device 26 is disposed at the focal point of the lens 30, the surface of the hologram recording medium 34 serves as an imaging surface at which each image displayed on the display device 26 is formed. The focal length f3 of the lens 32 is determined so that the surface of the hologram recording medium 34 serves as a converging surface.

The display device 26 displays multiple images over the display area divided into segments in the vertical direction. Multiple object beams that have been transmitted through the corresponding multiple images are transmitted through the corresponding cylindrical concave lenses of the lens array 54. The multiple object beams that have been transmitted through the lens array 54 are imaged and converged by the lens 30 and the lens 32 and applied to the hologram recording medium 34.

By replacing the lens array 28 including multiple cylindrical convex lenses illustrated in FIG. 3 with the lens array 54 including multiple cylindrical concave lenses illustrated in FIG. 9, the display device 26 is allowed to be disposed at the focal point of the lens 30. Thus, the size of the optical system is further reduced than that in the case of the first exemplary embodiment.

FIG. 10 is a configuration diagram of a modified example of the optical system according to the fourth exemplary embodiment. As illustrated in FIG. 10, one convex lens 56 may be used instead of two cylindrical lens illustrated as the lens 30 and the lens 32 in FIG. 9, as in the case of the third exemplary embodiment, to simplify the optical system.

### Fifth Exemplary Embodiment

In a fifth exemplary embodiment, the display device 26 displays multiple display images over the display area divided into segments not only in the vertical direction but also in the horizontal direction. Multiple strip-shaped component holograms that are to be recorded so as to be superimposed one on top of another in accordance with multiple display images displayed so as to be arranged in the vertical direction are recorded on the hologram recording medium 34 at a time so as to be arranged in the horizontal direction.

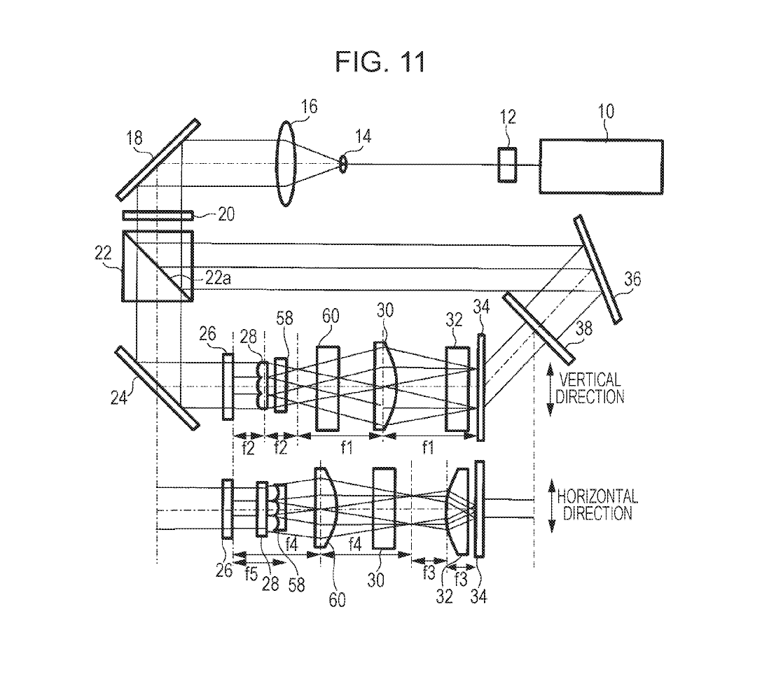

FIG. 11 is a configuration diagram of an example of the configuration of an image recording device according to the fifth exemplary embodiment. Except that the optical system is changed, the fifth exemplary embodiment has the same components as those of the first exemplary embodiment. Thus, only the different points are described and the same components are not described. As illustrated in FIG. 11, a transmissive display device 26, a lens array 28, a lens array 58, a lens 60, a lens 30, and a lens 32 are disposed between the mirror 24 and the hologram recording medium 34 in this order from the mirror 24 along the optical path.

The lens array 28 includes multiple cylindrical convex lenses. Each of the multiple cylindrical convex lenses is disposed in such a manner that its convex surface faces the display device 26 and that its lengthwise direction coincides with the horizontal direction. The multiple cylindrical convex lenses are arranged in the vertical direction so as to correspond to the respective segments into which the display area of the display device 26 is divided in the vertical direction.

The lens array 58 includes multiple cylindrical concave lenses. Each of the multiple cylindrical concave lenses is disposed in such a manner that its concave surface faces the lens array 28 and its lengthwise direction coincides with the vertical direction. The multiple cylindrical concave lenses are arranged in the horizontal direction so as to correspond to the respective segments into which the display area of the display device 26 is divided in the horizontal direction.

The lens 60 is a cylindrical lens. The lens 60 is disposed in such a manner that its convex surface faces the lens 30 and its lengthwise direction coincides with the vertical direction. The lens 60 functions as an imaging lens that images the object beams that have been transmitted through the lens array 28 and the lens array 58 in such a manner that the object beams are superimposed one on top of another in the horizontal direction in front of the lens 32.

The focal length f1 of the lens 30 and the focal length f2 of each cylindrical convex lens of the lens array 28 are determined so that, when the display device 26 is disposed at the focal point of each cylindrical convex lens of the lens array 28, the surface of the hologram recording medium 34 serves as an imaging surface on which each image displayed on the display device 26 is formed.

A focal length f4 of the lens 60 and a focal length f5 of each cylindrical concave lens of the lens array 58 are determined so that, when the display device 26 is disposed at the focal point of the lens 60, multiple object beams that have been transmitted through the lens 60 are imaged while being superimposed in the horizontal direction in front of the lens 32. A focal length f3 of the lens 32 is determined so that the surface of the hologram recording medium 34 serves as a Fourier transformation surface at which the images imaged while being superimposed in the horizontal direction in front of the lens 32 are subjected to Fourier transformation.

Now, multiple images displayed on the display device 26 are described.

FIG. 7A is a schematic diagram of an example of multiple images displayed on the display device 26 according to the fifth exemplary embodiment. The object OB is sequentially photographed from different viewpoints slightly shifted from one another in the horizontal direction and the vertical direction to acquire nine original images A, E, I, B, F, J, C, G, and K. Three original images E, F, and G acquired at the same angle in the vertical direction are rearranged to generate display images 1, 2, and 3. Three original images A, B, and C acquired at the same angle in the vertical direction are rearranged to generate display images 4, 5, and 6. Three original images I, J, and K acquired at the same angle in the vertical direction are rearranged to generate display images 7, 8, and 9. The generated multiple display images 1 to 9 are displayed while being arranged in the horizontal direction and the vertical direction in accordance with the directions of parallax.

In the fifth exemplary embodiment, the display area of the display device 26 is divided into three segments in the horizontal direction and three segments in the vertical direction to obtain nine segments. The display images 1 to 9 are allocated to the respective segments to be displayed on the segments. Among the three image columns divided in the horizontal direction, three display images 4, 1, and 7 are displayed in the first column so as to be arranged in the vertical direction, three display images 5, 2, and 8 are displayed in the second column so as to be arranged in the vertical direction, and three display images 6, 3, and 9 are displayed in the third column so as to be arranged in the vertical direction.

Multiple display images displayed in the same image row are acquired at the same angle in the vertical direction and have horizontal parallax information. The three display images 4, 5, and 6 arranged in the first row are acquired at the same angle in the vertical direction and have horizontal parallax information. The three display images 1, 2, and 3 arranged in the second row are acquired at the same angle in the vertical direction and have horizontal parallax information. The three display images 7, 8, and 9 arranged in the third row are acquired at the same angle in the vertical direction and have horizontal parallax information.

Multiple object beams that have been transmitted through the respective multiple display images displayed on the display device 26 are transmitted through the corresponding cylindrical convex lenses of the lens array 28 and then are transmitted through the corresponding cylindrical concave lenses of the lens array 58. The multiple object beams that have been transmitted through the lens array 28 and the lens array 58 are imaged on the hologram recording medium 34 by the lens 30 while being superimposed one on top of another in the vertical direction. Specifically, the optical axes of the imaged multiple object beams have different angles in the vertical direction.

The multiple object beams that have been transmitted through the lens array 28 and the lens array 58 are imaged by being superimposed by the lens 60 in the horizontal direction in front of the lens 32. Specifically, the optical axes of the imaged multiple object beams have different angles in the horizontal direction. Furthermore, the multiple object beams imaged by being superimposed in the horizontal direction are converged by the lens 32 in the horizontal direction. At this time, the optical axes of the multiple object beams have different angles in the horizontal direction. Thus, the multiple object beams are converged by the lens 32 at different points in the horizontal direction that differ depending on the image column. In this manner, the imaged and converged object beams are applied to the hologram recording medium 34.

In the fifth exemplary embodiment, multiple different display images are displayed on the display device 26 so as to be arranged in the horizontal direction and the vertical direction. The multiple display images are acquired at different angles in the vertical direction and have horizontal parallax information. Light beams that have been transmitted through the multiple display images displayed on the display device 26 become multiple object beams that are adjacent to one another in the horizontal direction and in which the optical axes of the multiple object beams have different angles in the vertical direction in accordance with the direction of parallax. When these multiple object beams and the reference beam are concurrently applied to the hologram recording medium 34, component holograms corresponding to multiple images are recorded at a time due to interference between the multiple object beams and the reference beam.

Component holograms corresponding to multiple images displayed on the same column of the display area of the display device 26 are recorded over the same area of the hologram recording medium 34 so as to be superimposed one on top of another. Each of the multiple component holograms that are to be recorded so as to be superimposed is in a strip shape. The multiple component holograms that are to be recorded so as to be superimposed are recorded so that the holograms of different image columns are recorded on different portions of the hologram recording medium 34 in the horizontal direction.

The multiple component holograms that are to be recorded so as to be superimposed are in a strip shape having its lengthwise direction aligned with the vertical direction and recorded in such a manner that multiple strips are arranged in the horizontal direction. By moving the hologram recording medium 34 in the horizontal direction and switching the images displayed on the display device 26 from one to another, multiple different strips (multiple component holograms that are to be recorded so as to be superimposed) are sequentially recorded on the hologram recording medium 34. In this exemplary embodiment, three strips are recorded at each time.

From the component holograms corresponding to multiple images recorded on the hologram recording medium 34, images having parallax in different directions are reproduced in accordance with the observation angles. Specifically, a holographic stereogram having both of horizontal parallax information and vertical parallax information is formed. In addition, parallax information for multiple images is recorded at a time. Thus, the speed at which component holograms are recorded is significantly higher than that in the case of an existing image recording device that performs recording pixel by pixel.

FIG. 7A illustrates an example of display images for each time. To acquire display images for multiple times, for example, the object OB is sequentially photographed from different viewpoints slightly shifted from one another in the horizontal direction and the vertical direction to acquire 3×(2n+1) original images. Here, n denotes an integer greater than or equal to two. Throughout the three rows of original image sets each having (2n+1) columns, the images have the same angle in the vertical direction. A display image set 1 is acquired by rearranging the original image set of the first row in accordance with the horizontal parallax. A display image set 2 is acquired by rearranging the original image set of the second row in accordance with the horizontal parallax. A display image set 3 is acquired by rearranging the original image set of the third row in accordance with the horizontal parallax.

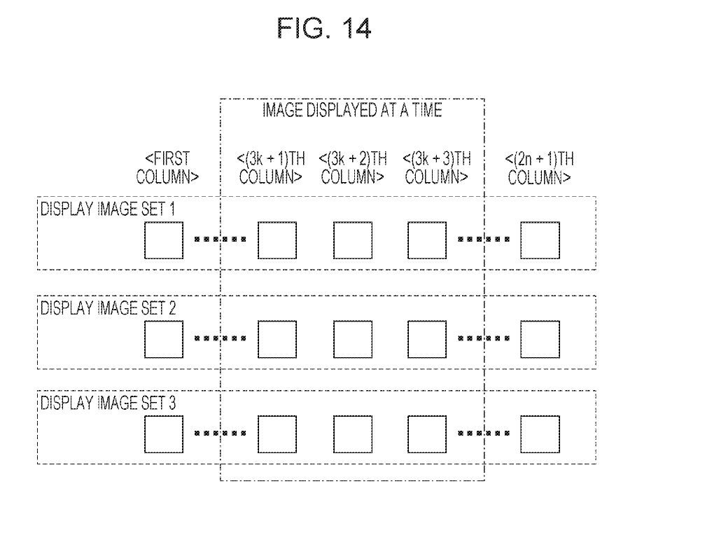

The following describes a case where three sets of (2n+1) display images is acquired from three sets of (2n+1) original images. As illustrated in FIG. 14, the display area of the display device 26 is divided into three segments in the horizontal direction and three segments in the vertical direction to form nine segments. The display image sets 1 to 3 are allocated to the respective image rows acquired by dividing the display area into three segments in the vertical direction. On each of the image columns acquired by dividing the display area into three segments in the horizontal direction, the corresponding display image of the (3k+1)th column, the (3k+2)th column, or the (3k+3)th column is displayed. Here, k is an integer greater than or equal to zero and is sequentially incremented from zero. Here, (3k+3)≦(2n+1).

For example, at a first time, the display images of the first column, the second column, and the third column are displayed. At a second time, the display images of the fourth column, the fifth column, and the sixth column are displayed. At a k-th time, the display images of the (3k+1)th column, the (3k+2)th column, and the (3k+3)th column are displayed. Here, multiple display images, the number of which is larger than the number of multiple original images, may be formed.

### Sixth Exemplary Embodiment

In a sixth exemplary embodiment, the display device 26 displays multiple original images over the display area divided into segments in the horizontal direction and the vertical direction. Rectangular component holograms recorded so as to be superimposed in accordance with the displayed multiple original images are recorded on the hologram recording medium 34 at a time.

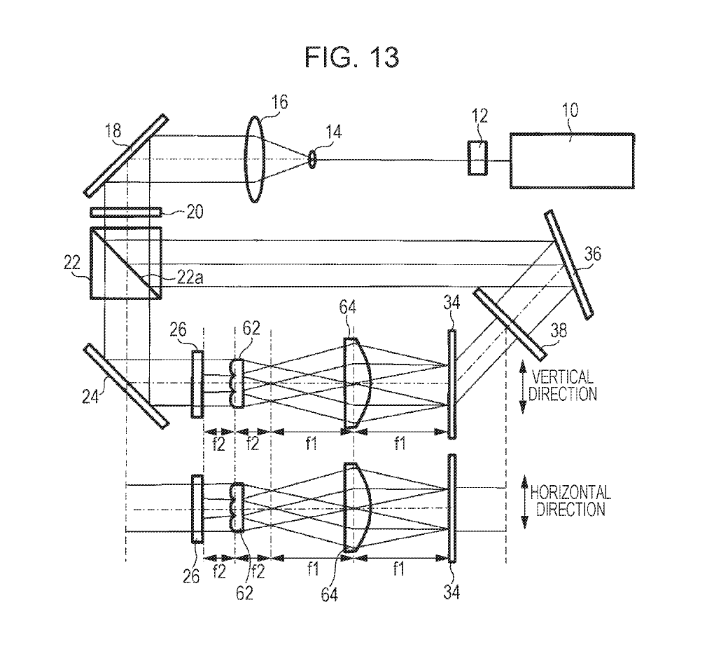

FIG. 13 is a configuration diagram of an example of the configuration of an image recording device according to the sixth exemplary embodiment. Except that the optical system is changed, the sixth exemplary embodiment has the same components as those of the first exemplary embodiment. Thus, only the different points are described and the same components are not described. As illustrated in FIG. 13, a transmissive display device 26, a lens array 62, and a lens 64 are disposed between the mirror 24 and the hologram recording medium 34 in this order from the mirror 24 along the optical path.

The lens array 62 includes multiple convex lenses. Each of the multiple convex lenses is disposed in such a manner that its convex surface faces the display device 26. The multiple convex lenses are disposed in such a manner as to correspond to multiple images displayed on the segments of the display area of the display device 26 into which the display area is divided in the horizontal direction and the vertical direction.

The lens 64 is a convex lens. The lens 64 is disposed in such a manner that its convex surface faces the hologram recording medium 34. The lens 64 functions as an imaging lens that images the multiple object beams that have been transmitted through the lens array 62 on the hologram recording medium 34 so that the object beams are superimposed one on top of another.

A focal length f1 of the lens 64 and a focal length f2 of each convex lens of the lens array 62 are determined so that, when the display device 26 is disposed at the focal point of each convex lens of the lens array 62, the surface of the hologram recording medium 34 serves as an imaging surface on which each image displayed on the display device 26 is formed.

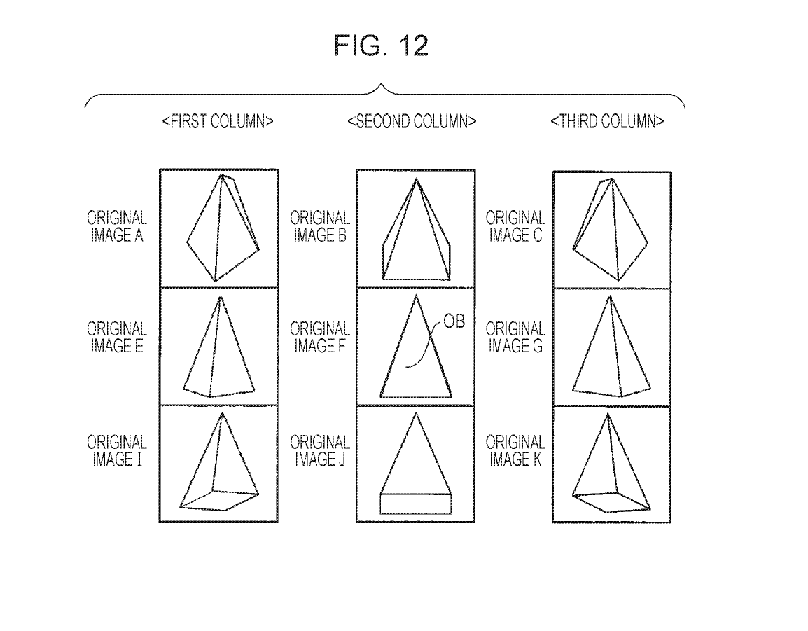

In this exemplary embodiment, as illustrated in FIG. 12, multiple different original images are displayed over the display area of the display device 26 so as to be arranged in the horizontal direction and the vertical direction. For example, the display area of the display device 26 is divided into three segments in the horizontal direction and three segments in the vertical direction to form nine segments. The above-described nine original images A, E, I, B, F, J, C, G, and K are displayed on the respective segments. The acquired multiple original images A to K are displayed so as to be arranged in the horizontal direction and the vertical direction in accordance with directions of parallax, for example, the original images A, E, and I are arranged in the first column, the original images B, F, and J are arranged in the second column, and the original image C, G, and K are arranged in the third column.

The multiple object beams that have been transmitted through the respective multiple original images displayed on the display device 26 are transmitted through the corresponding lenses of the lens array 62. The multiple object beams that have been transmitted through the lens array 62 are imaged by the lens 64 on the hologram recording medium 34 while being superimposed one on top of another. Specifically, the optical axes of the imaged multiple object beams have different angles in the horizontal direction and the vertical direction in accordance with the direction of parallax.

When the reference beam and the multiple object beams corresponding to the different original images are concurrently applied to the hologram recording medium 34, component holograms corresponding to multiple images are recorded at a time due to interference between the multiple object beams and the reference beam. The component holograms corresponding to multiple images displayed over the display area of the display device 26 are recorded so as to be superimposed over the same area of the hologram recording medium 34.

In the sixth exemplary embodiment, multiple different original images are displayed on the display device 26 so as to be arranged in the horizontal direction and the vertical direction. The displayed multiple original images have horizontal parallax and vertical parallax. Light beams that have been transmitted through the displayed multiple original images become multiple object beams whose optical axes have different angles in the horizontal direction and the vertical direction in accordance with the directions of parallax. Component holograms corresponding to multiple images are recorded at a time due to interference between the multiple object beams and the reference beam.

The component holograms corresponding to multiple images are recorded over the same area of the hologram recording medium 34 so as to be superimposed one on top of another. From the multiple component holograms recorded so as to be superimposed, different original images are reproduced in accordance with different observation angles. Specifically, a holographic stereogram having both of horizontal parallax information and vertical parallax information is formed. In this exemplary embodiment, multiple component holograms corresponding to multiple original images are recorded so as to be superimposed one on top of another so that a holographic stereogram having both of horizontal parallax information and vertical parallax information is formed. Thus, this configuration dispenses with the need of rearrangement of original images to generate display images, whereby image processing is simplified.

Each of the multiple component holograms recorded so as to be superimposed is rectangular since it is not converged in the horizontal direction. By moving the hologram recording medium 34 in the horizontal direction and switching the images displayed on the display device 26 from one to another, rectangular component holograms recorded so as to be superimposed one on top of another are sequentially recorded on the hologram recording medium 34 so as to be arranged in the horizontal direction.

In addition, parallax information for multiple images is recorded at a time. Thus, the speed at which component holograms are recorded is significantly higher than that in the case of an existing image recording device that records component holograms pixel by pixel. For example, when a rectangular component hologram has 100×100 pixels, the speed at which recording on a holographic stereogram is performed is 10000 times higher.

As in the case of the fifth exemplary embodiment, an example illustrated in FIG. 12 shows display images displayed at a time. To acquire display images for multiple times, an object OB is sequentially photographed from different viewpoints slightly shifted from one another in the horizontal direction and the vertical direction to acquire 3×(2n+1) original images. Here, n denotes an integer greater than or equal to two. In each of three image columns acquired by dividing the display area in the horizontal direction into three segments, display images of the (3k+1)th column, the (3k+2)th column, or the (3k+3)th column is displayed. Here, k is an integer greater than or equal to zero and is sequentially incremented from zero. Here, (3k+3) (2n+1).

The above-described configuration of the image recording device according to each exemplary embodiment is merely an example. The configuration is naturally allowed to be changed within a range not departing from the gist of the invention.

For example, each exemplary embodiment describes a case where a transmissive display device is used. However, a reflective display device may be used, instead. Each exemplary embodiment describes a case where a monochromatic green hologram is recorded using a laser beam of a wavelength of 532 nm. However, a full-color holographic stereogram may be formed by performing sequential or concurrent recording using laser beams of three colors having different wavelengths.

In each exemplary embodiment, recording is performed while the hologram recording medium 34 is being moved in the horizontal direction. However, component holograms that are to be recorded so as to be superimposed one on top of another may be sequentially recorded on the hologram recording medium 34 so as to be arranged in the horizontal direction and the vertical direction while the hologram recording medium 34 is being moved in the horizontal direction and the vertical direction.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An image recording device, comprising:
a laser beam source that emits a laser beam;
a splitting unit that splits the laser beam emitted from the laser beam source into two laser beams;
a display device that displays images over a display area thereof divided into segments;
a display controller that controls display of the display device so that a plurality of images for forming a holographic stereogram are displayed on the segments of the display area and so that one of the laser beams split by the splitting unit is modulated by the plurality of images displayed on the display device to become a plurality of object beams;
an optical system that images the plurality of object beams on a hologram recording medium so that the object beams are superimposed one on top of another; and
an irradiating unit that irradiates the hologram recording medium with, besides the plurality of object beams, the other laser beam split by the splitting unit as a reference beam.

2. The image recording device according to claim 1, wherein optical axes of the plurality of object beams have different angles.

3. The image recording device according to claim 1, wherein the plurality of images are identical images.

4. The image recording device according to claim 1, wherein the plurality of images have horizontal parallax information or vertical parallax information.

5. The image recording device according to claim 1, wherein the plurality of images have horizontal parallax information and vertical parallax information.

6. The image recording device according to claim 1, wherein the optical system converges the object beams in a direction in which the holographic stereogram has parallax information.

7. The image recording device according to claim 1, wherein the optical system includes a lens array and an imaging lens, the lens array including a plurality of lenses disposed so as to correspond to the segments of the display area of the display device, the imaging lens imaging a plurality of object beams that have been transmitted through the plurality of lenses on the hologram recording medium so that the object beams are superimposed one on top of another.

8. The image recording device according to claim 7, wherein the plurality of lenses are concave lenses.

9. The image recording device according to claim 1, wherein the display controller causes the display device to display a plurality of images having vertical parallax information in such a manner that the images are arranged in a vertical direction to form a holographic stereogram having horizontal parallax information.

10. The image recording device according to claim 9, wherein the optical system includes a lens array and a cylindrical lens, the lens array including a plurality of cylindrical lenses arranged in a vertical direction, the cylindrical lens imaging a plurality of object beams that have been transmitted through the plurality of cylindrical lenses on the hologram recording medium so that the object beams are superimposed one on top of another.

11. The image recording device according to claim 1, wherein the display controller causes the display device to display a plurality of images having horizontal parallax information and vertical parallax information in such a manner that the images are arranged in a horizontal direction and a vertical direction to form a holographic stereogram having horizontal parallax information and vertical parallax information.

12. The image recording device according to claim 11, wherein the optical system includes a lens array and a convex lens, the lens array including a plurality of convex lenses arranged in a horizontal direction and a vertical direction, the convex lens imaging a plurality of object beams that have been transmitted through the plurality of convex lenses on the hologram recording medium so that the object beams are superimposed one on top of another.
